(19) United States
(12) Patent Application Publication
(10) Pub. No.: US 2008/0013824 A1
(43) Pub. Date: Jan. 17, 2008

(54) Defect inspection method, defect inspection apparatus, and semiconductor device manufacturing method

(76) Inventors: Shinji Yamaguchi, Tokyo (JP); Koji Hashimoto, Yokohama-shi (JP); Yuichiro Yamazaki, Tokyo (JP); Ichirota Nagahama, Koga-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/822,970

(22) Filed: Jul. 11, 2007

(30) Foreign Application Priority Data
Jul. 11, 2006 (JP) 2006-190613

(51) Int. Cl. G06K 9/00

(52) U.S. Cl. 382/149

(57) ABSTRACT

According to an aspect of the invention, there is provided a defect inspection method of inspecting a defect of a patterned inspection object, the method including extracting a feature pattern having an alignable shape from one of pattern data and an image of the inspection object, and aligning a local area of the inspection object by using the feature pattern.

### CROSS-REFERENCE TO RELATED APPLICATIONS

This application is based upon and claims the benefit of priority from prior Japanese Patent Application No. 2006-190613, filed Jul. 11, 2006, the entire contents of which are incorporated herein by reference.

### BACKGROUND OF THE INVENTION

1. Field of the Invention

The present invention relates to a defect inspection method and defect inspection apparatus for a semiconductor wafer or photomask for use in, e.g., the fabrication of a semiconductor integrated circuit, and semiconductor device manufacturing method.

2. Description of the Related Art

Recently, integration and micropatterning of elements and interconnections forming circuits are advancing in the fabrication of semiconductor memories. Conventionally, photomasks or wafers are inspected by die-to-die comparison inspection that compares adjacent identical patterns, cell-to-cell comparison inspection, or die-to-database comparison inspection that compares a pattern with design pattern data.

In the die-to-die comparison inspection and cell-to-cell comparison inspection, an inspection image is obtained by irradiating a desired portion in an inspection area with a laser beam or electron beam (EB), and compared with an inspection image of a die or cell to be compared. A certain threshold value is defined for the intensity distribution of the compared inspection image, and a portion exceeding this threshold value is detected as a defect. Coordinate data (including defect sizes and defect images) of detected defects are stored, and recorded as defect data in an inspection apparatus.

On the other hand, in the die-to-database comparison inspection, an inspection image is predicted from design data, and stored in an inspection apparatus as reference (inspection) data for use in comparison inspection. Inspection is performed by comparing the stored reference data with an actual inspection image.

In the conventional optical inspection, alignment is first performed in the X direction by using alignment marks on regions in the lateral direction of a photomask or semiconductor wafer, and then performed in the Y direction by using alignment marks on regions in the longitudinal direction, thereby aligning the whole inspection area. Subsequently, the photomask or wafer is inspected by comparing the obtained inspection image with reference data.

Since, however, the pixel size of the obtained inspection image is larger than the pattern size, the pattern edge is difficult to detect. In addition, since signals from patterns reduce as micropatterning advances, an inspection error occurs due to an alignment error. This causes interruption of the inspection or produces noise (a pseudo defect).

Also, in the electron beam inspection, after the whole inspection area is aligned, a photomask or wafer is inspected by comparing the obtained inspection image with reference data, in the same manner as in the optical inspection.

Unfortunately, electric charge unique to the electron beam inspection builds up in a pattern on a sample (the pattern is charged), and this charge amount changes with time to bend an incident electron beam, thereby causing a drift phenomenon of the inspection image. As a consequence, an inspection error occurs due to an alignment error, and this causes interruption of the inspection or produces noise (a pseudo defect).

Note that Jpn. Pat. Appln. KOKAI Publication No. 11-97510 has disclosed a circuit pattern inspection apparatus and an alignment method of a dimension measurement apparatus that can be used to, e.g., inspect defects of a circuit pattern drawn on a photomask, reticle, wafer, or the like, by inputting an optical image by sensing an image of the circuit pattern.

### BRIEF SUMMARY OF THE INVENTION

According to an aspect of the invention, there is provided a defect inspection method of inspecting a defect of a patterned inspection object, the method comprising: extracting a feature pattern having an alignable shape from one of pattern data and an image of the inspection object; and aligning a local area of the inspection object by using the feature pattern.

According to another aspect of the invention, there is provided a defect inspection apparatus for inspecting a defect of a patterned inspection object, the apparatus comprising: an extraction section which extracts a feature pattern having an alignable shape from one of pattern data and an image of the inspection object; and an alignment section which aligns a local area of the inspection object by using the extracted feature pattern.

According to another aspect of the invention, there is provided a semiconductor device manufacturing method of manufacturing a semiconductor device by using a patterned semiconductor substrate which is subjected to a defect inspection, the method comprising: extracting a feature pattern having an alignable shape from one of pattern data and an image of the semiconductor substrate; and aligning a local area of the semiconductor substrate by using the feature pattern.

### BRIEF DESCRIPTION OF THE SEVERAL VIEWS OF THE DRAWING

FIG. 1 is a view showing the arrangement of a die-to-database defect inspection apparatus according to an embodiment;

FIG. 2 is a view for explaining a die-to-database inspection method according to the embodiment, which shows an arbitrary portion in an inspection area;

FIG. 3 is a view for explaining the die-to-database inspection method according to the embodiment;

FIG. 4 is a view for explaining the die-to-database inspection method according to the embodiment, which shows the addresses of divisional data and symbolization of the presence/absence of a feature pattern;

FIG. 5 is a view for explaining the die-to-database inspection method according to the embodiment, which shows symbolization of a feature pattern;

FIG. 6 is a view for explaining the die-to-database inspection method according to the embodiment, which shows alignment of the whole inspection area;

FIG. 7 is a view for explaining the die-to-database inspection method according to the embodiment, which shows alignment of a local area and the inspection order; and

FIG. 8 is a view showing the arrangement of a die-to-die defect inspection apparatus according to the embodiment.

### DETAILED DESCRIPTION OF THE INVENTION

An embodiment will be explained below with reference to the accompanying drawing.

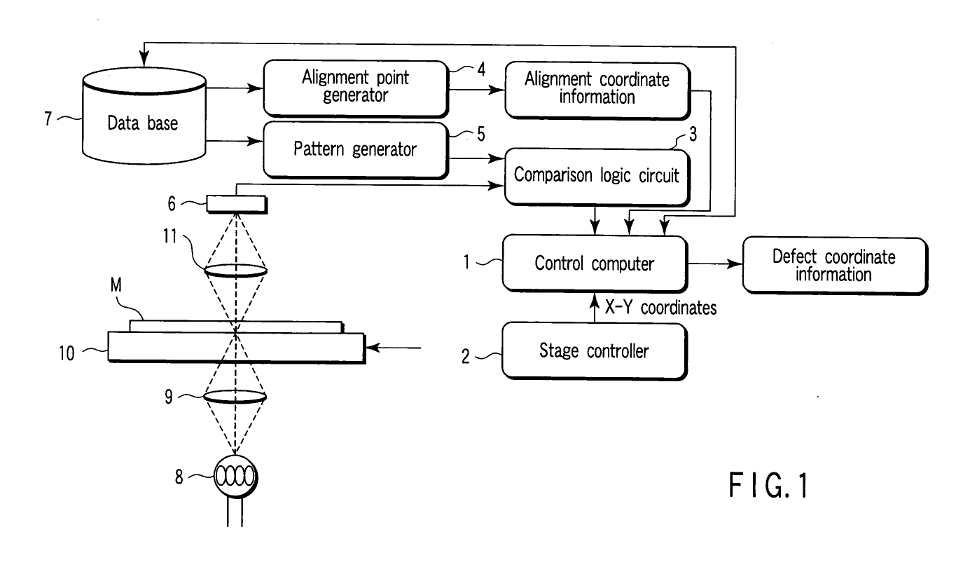

FIG. 1 is a view showing the arrangement of a die-to-database defect inspection apparatus according to, the embodiment. Referring to FIG. 1, a control computer 1 is connected to a stage controller 2, comparison logic circuit 3, alignment point generator 4, and database 7. The database 7 stores design data. The comparison logic circuit 3 is connected to a pattern generator 5 and image sensor 6. The database 7 is connected to the alignment point generator 4 and pattern generator 5. Also, a lens 9, an X-Y stage 10 on which a photomask M is placed, an objective lens 11, and the image sensor 6 are arranged on the optical axis of a light source 8.

In FIG. 1, the alignment point generator 4 generates an area to be aligned in inspection by using a desired algorithm beforehand for desired inspection mask data in the database 7. Then, the alignment point generator 4 transfers alignment coordinate information to the control computer 1.

Subsequently, for the desired inspection mask data in the database 7, the pattern generator 5 assumes and generates an inspection image from the desired inspection mask. To inspect an inspection area to be compared by the comparison logic circuit 3, at a desired timing the control computer 1 transmits information to the stage controller 2 and also transmits, to the stage controller 2, the alignment coordinate information transferred to the control computer 1.

At a desired timing, the stage controller 2 performs alignment on the basis of the alignment coordinate information. In addition, in a desired inspection area, the comparison logic circuit 3 compares reference data generated by the pattern generator 5 and output from a database 7 with inspection data obtained from the inspection image. The control computer 1 sets a desired threshold value, determines that a portion different from this threshold value is a defect, and outputs defect coordinate information.

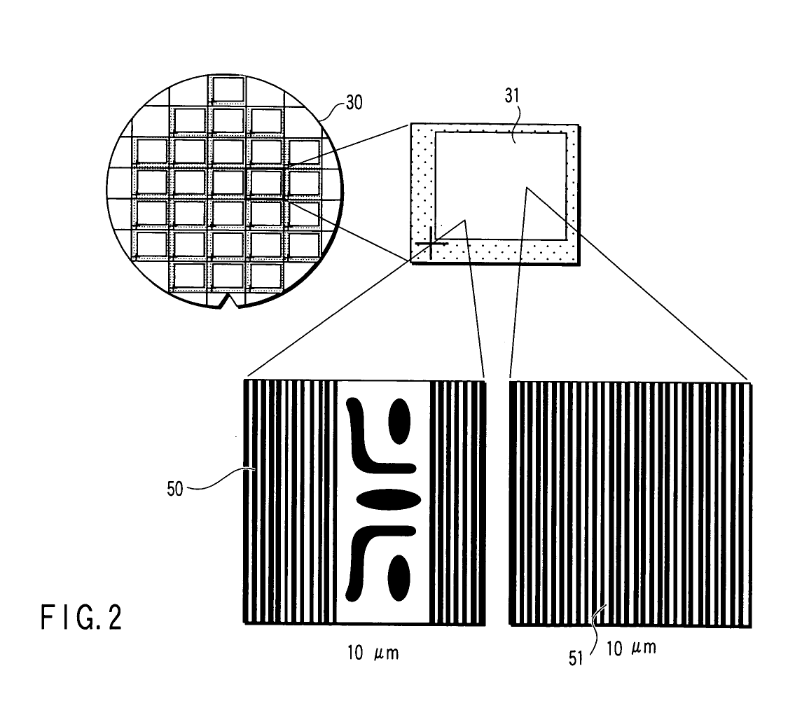

FIGS. 2 to 7 are views for explaining a die-to-database comparison inspection (database pattern comparison inspection) method according to this embodiment.

First, as shown in FIG. 2, a patterned semiconductor wafer (Si wafer substrate) 30 to be inspected is prepared. Then, the control computer 1 separates design pattern data of the same region as an inspection area 31 stored in the database 7 into a pattern 50 having a feature for performing alignment (local area alignment) and a pattern 51 having no feature. The dimensions of each divisional region of the inspection area are 10×10 μm².

Note that the pattern having a feature for alignment is a pattern having an alignable shape, and extracted from the design pattern data by searching for pattern edge information or coordinates parallel to the pattern edge and using the found information.

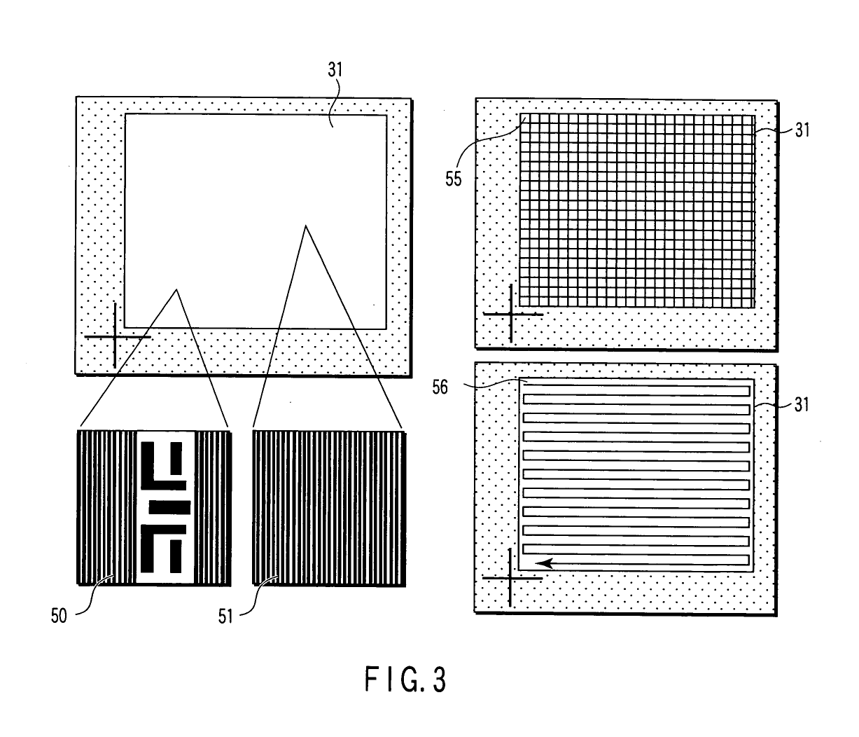

Then, as shown in FIG. 3, the control computer 1 divides the design pattern data in the inspection area 31, determines the inspection order for individual divisional data 55, and adds addresses to the divisional data 55 in the entire design pattern data. In this case, as indicated by an arrow 56, the control computer 1 adds addresses 1, 2, 3, . . . to the divisional data 55 from the upper left corner to the right in the inspection area 31. When reaching the upper right corner (25), the control computer 1 advances downward and adds addresses 26, 27, . . . to the divisional data from the right to the left by taking the inspection order into consideration.

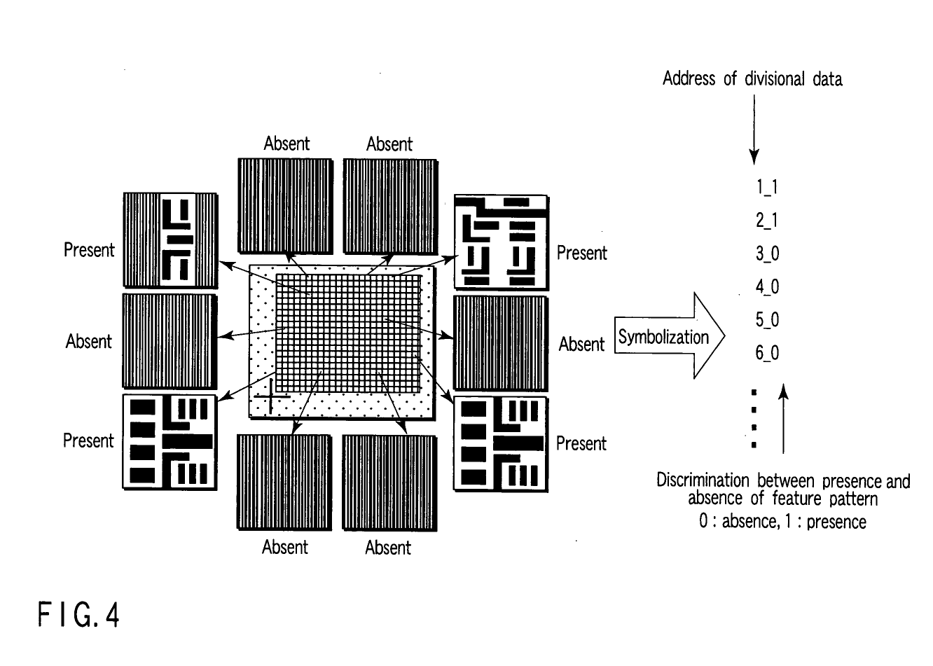

As shown in FIG. 4, the control computer 1 checks whether each divisional data 55 has a feature pattern capable of alignment (local area alignment), and adds information (0: absent, 1: present) for discriminating between the presence and absence of the feature pattern to the address of each divisional data 55.

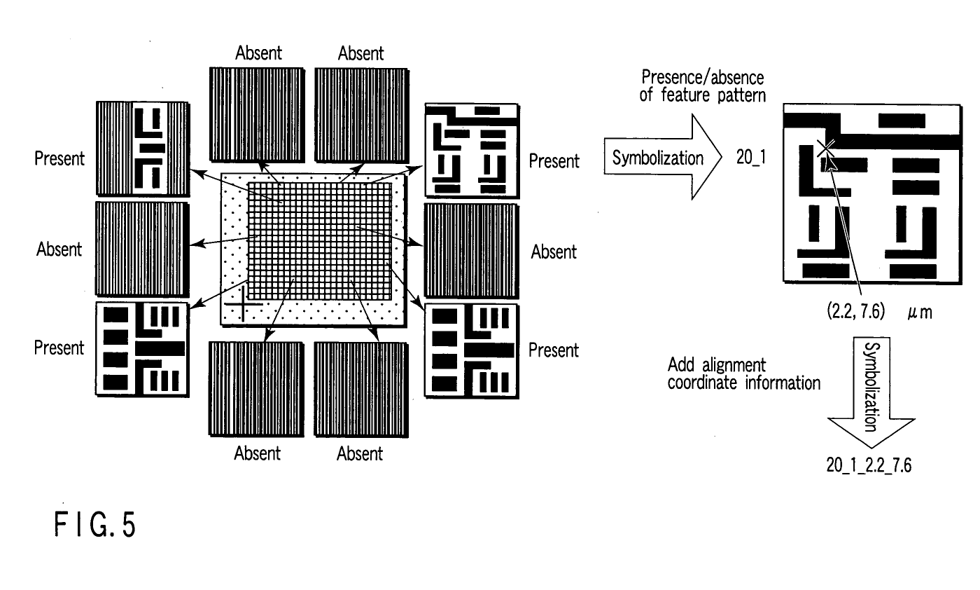

As shown in FIG. 5, the control computer 1 adds, to the address of divisional data 55 having the feature pattern (alignment pattern) capable of alignment, the coordinates (alignment coordinates) of the feature pattern and its pattern data.

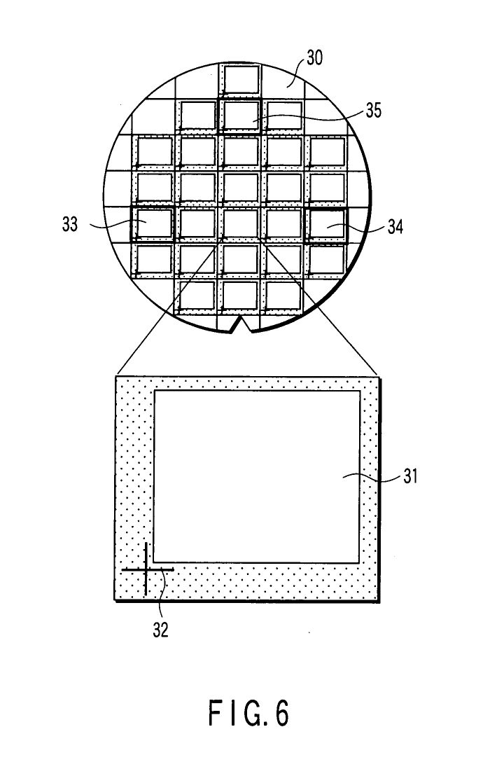

Then, the control computer 1 transfers the wafer substrate 30 into the inspection apparatus, and aligns the entire inspection area by using alignment marks in the same manner as in the conventional method. More specifically, as shown in FIG. 6, the control computer 1 performs alignment in the X direction by using alignment marks 32 on regions 33 and 34 in the lateral direction of the semiconductor wafer 30, and performs alignment in the Y direction by using alignment marks 32 on the regions 33 and 34 and a region 35 in the longitudinal direction, thereby aligning the whole inspection area. Subsequently, the control computer 1 starts a die-to-database comparison inspection step.

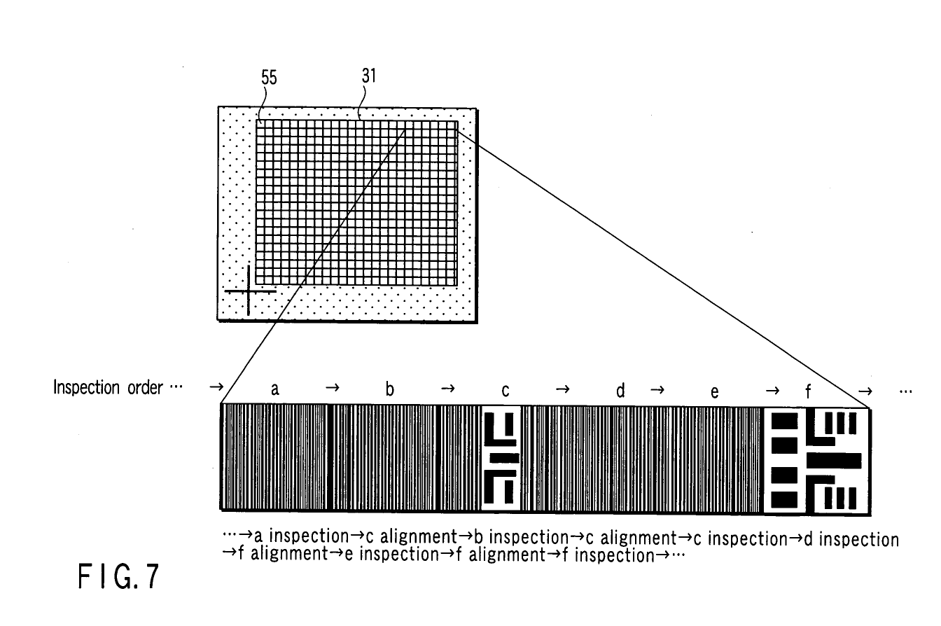

In this embodiment, the control computer 1 performs inspection by referring to the divisional data 55 in the order as shown in FIG. 7. FIG. 7 shows divisional data a, b, c, d, e, and f in the inspection area 31 in an enlarged scale. Defect inspection is performed in the order of . . . →a→b→c→d→e→f→ . . . .

When reaching divisional data 55 (e.g., b) having no alignable feature pattern during inspection, the control computer 1 obtains the address of divisional data 55(c) near the address of the divisional data 55(b) and having an alignable feature pattern. On the basis of this address, the control computer 1 obtains the nearest divisional data 55(c) having an alignable feature pattern. Subsequently, the control computer 1 refers to the divisional data 55(c), and causes the stage controller 2 to move the stage 10 so as to align the optical axis of the light source 8 with the alignable pattern of the divisional data 55(c), thereby performing alignment (local area alignment). After that, the control computer 1 returns to the address of the divisional data 55(b) currently being inspected, and continues die-to-database comparison inspection.

That is, . . . →a inspection→c alignment→b inspection→c alignment→c inspection→d inspection→f alignment→e inspection→f alignment→f inspection→ . . . in the inspection step shown in FIG. 7. A semiconductor device is manufactured by using the semiconductor substrate which is subjected to the defect inspection described above.

This embodiment extracts an alignment pattern capable of aligning a local area from pattern data of an inspection area in design data, and aligns the local area by using the extracted alignment pattern. However, it is also possible to extract an alignment pattern capable of aligning a local area from total design data including pattern data other than an inspection area, and perform alignment by using the alignment pattern. Furthermore, the timing at which alignment is performed during inspection can also be defined by time.

This embodiment is applicable not only to semiconductor wafer defect inspection, but also to any pattern inspection using pattern data, such as photomask defect inspection.

Note that this embodiment defines an alignment pattern capable of aligning a local area by extracting divisional data including the pattern, and extracting alignment coordinates from the extracted divisional data. However, any other method can also be used as the alignment pattern defining method.

In addition, an alignment pattern capable of alignment can also be extracted by defining it by the edge length of pattern edge information.

When performing optical defect inspection, an alignment pattern capable of alignment can also be extracted from design pattern data by defining the alignment pattern as a pattern that increases the contrast of an optical image during inspection.

When performing electron beam defect inspection, an alignment pattern capable of alignment can also be extracted from design pattern data by defining the alignment pattern as a pattern that causes no image drift during inspection.

Furthermore, when performing optical defect inspection or electron beam defect inspection, an alignment pattern capable of alignment can also be extracted from design pattern data by defining the alignment pattern as a pattern including many corner portions.

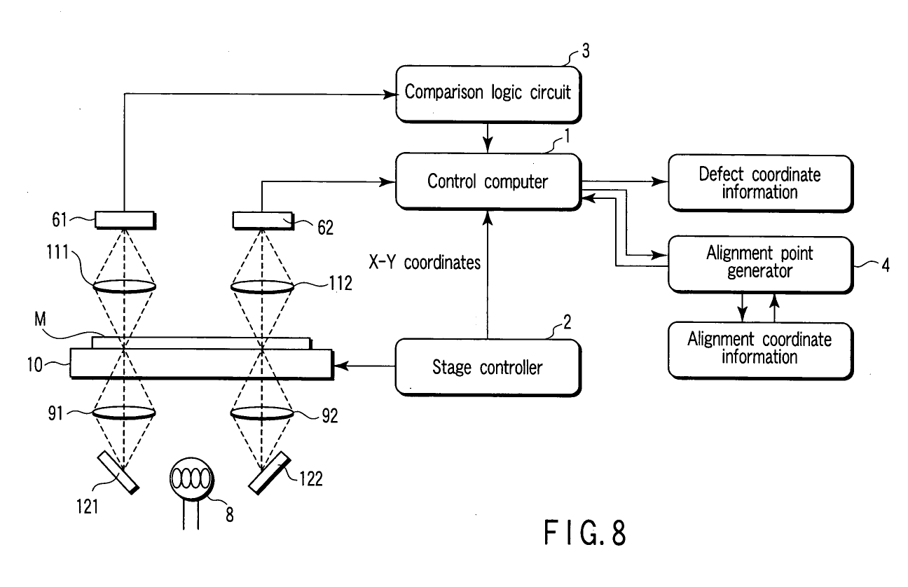

FIG. 8 is a view showing the arrangement of a die-to-die defect inspection apparatus according to this embodiment. Referring to FIG. 8, a control computer 1 is connected to a stage controller 2, comparison logic circuit 3, and alignment point generator 4. The comparison logic circuit 3 is connected to image sensors 61 and 62. Mirrors 121 and 122 are arranged on the optical axis of a light source 8. On the reflected light optical axes of the mirrors 121 and 122, lenses 91 and 92, an X-Y stage 10 on which a photomask M is placed, objective lens 111 and 112, and the image sensors 61 and 62 are respectively arranged.

In FIG. 8, inspection images of the same pattern in two portions are obtained in a desired inspection area, and the comparison logic circuit 3 compares these inspection images of the two portions. The control computer 1 sets a desired threshold value, determines that a portion different from this threshold value is a defect, and outputs defect coordinate information.

Simultaneously with the inspection image comparison described above, the alignment point generator 4 generates alignable feature patterns and pattern information from the inspection images, and records them as alignment points. If an area requiring alignment is reached during inspection and alignment is difficult to perform in that area, the control computer 1 detects the nearest feature pattern and its coordinates from the recorded alignment points, and performs alignment by using the pattern having the coordinates, thereby continuing defect inspection.

This embodiment is applicable not only to die-to-database comparison inspection, but also to die-to-die or cell-to-cell comparison inspection (pattern comparison inspection) using the apparatus shown in FIG. 8. In this case, in the inspection step, the control computer 1 obtains an alignable feature pattern and its coordinates from a sensed image of the photomask M, and records the obtained data. If an area requiring alignment is reached during inspection and alignment is difficult to perform in that area, the control computer 1 detects the nearest alignable feature pattern and its coordinates, and performs alignment by using the pattern having the coordinates, thereby continuing defect inspection.

When performing optical defect inspection, an alignment pattern capable of alignment can also be extracted from an optical image obtained during inspection by defining the alignment pattern as a pattern that increases the contrast of the image.

When performing electron beam defect inspection, an alignment pattern capable of alignment can also be extracted from an electron beam image obtained during inspection by defining the alignment pattern as a pattern that causes no image drift.

When performing electron beam defect inspection, an alignment pattern capable of alignment can also be extracted from an electron beam image obtained during inspection by defining the alignment pattern as a pattern that increases the contrast of the image.

Furthermore, when performing optical defect inspection or electron beam defect inspection, an alignment pattern capable of alignment can also be extracted from an image obtained during inspection by defining the alignment pattern as a pattern including many corner portions.

As described above, this embodiment extracts an alignment pattern capable of aligning a local area, performs inspection after aligning the local area by using the extracted alignment pattern. This makes it possible to perform defect inspection without any inspection error caused by an alignment error.

This embodiment can provide a defect inspection method, defect inspection apparatus, and semiconductor device manufacturing method capable of performing defect inspection without any inspection error caused by an alignment error.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A defect inspection method of inspecting a defect of a patterned inspection object, the method comprising:
extracting a feature pattern having an alignable shape from one of pattern data and an image of the inspection object; and
aligning a local area of the inspection object by using the feature pattern.

2. The method according to claim 1, wherein database pattern comparison inspection is performed after the alignment.

3. The method according to claim 1, wherein pattern comparison inspection is performed after the alignment.

4. The method according to claim 1, wherein the feature pattern is extracted by searching for one of pattern edge information and coordinate parallel to a pattern edge, and using the found information.

5. The method according to claim 1, wherein the pattern data is divided to determine an inspection order for individual divisional data, and information of the feature pattern is added to the divisional data.

6. The method according to claim 5, wherein when reaching first divisional data having no feature pattern during inspection, second divisional data having the feature pattern near the first divisional data is obtained, and the alignment is performed using the feature pattern of the second divisional data.

7. A defect inspection apparatus for inspecting a defect of a patterned inspection object, the apparatus comprising:
an extraction section which extracts a feature pattern having an alignable shape from one of pattern data and an image of the inspection object; and
an alignment section which aligns a local area of the inspection object by using the extracted feature pattern.

8. The defect inspection apparatus according to claim 7, further comprising a comparison inspection section which performs database pattern comparison inspection after the alignment.

9. The defect inspection apparatus according to claim 7, further comprising a comparison inspection section which performs pattern comparison inspection after the alignment.

10. The defect inspection apparatus according to claim 7, wherein the extraction section extracts the feature pattern by searching for one of pattern edge information and coordinate parallel to a pattern edge, and using the found information.

11. The defect inspection apparatus according to claim 7, further comprising a control section which divides the pattern data to determine an inspection order for individual divisional data to which information of the feature pattern is added.

12. The defect inspection apparatus according to claim 11, wherein when reaching first divisional data having no feature pattern during inspection, the control section obtains second divisional data having the feature pattern near the first divisional data, and the alignment section performs the alignment using the feature pattern of the second divisional data.

13. A semiconductor device manufacturing method of manufacturing a semiconductor device by using a patterned semiconductor substrate which is subjected to a defect inspection, the method comprising:
extracting a feature pattern having an alignable shape from one of pattern data and an image of the semiconductor substrate; and
aligning a local area of the semiconductor substrate by using the feature pattern.

14. The method according to claim 13, wherein database pattern comparison inspection is performed after the alignment.

15. The method according to claim 13, wherein pattern comparison inspection is performed after the alignment.

16. The method according to claim 13, wherein the feature pattern is extracted by searching for one of pattern edge information and coordinate parallel to a pattern edge, and using the found information.

17. The method according to claim 13, wherein the pattern data is divided to determine an inspection order for individual divisional data, and information of the feature pattern is added to the divisional data.

18. The method according to claim 17, wherein when reaching first divisional data having no feature pattern during inspection, second divisional data having the feature pattern near the first divisional data is obtained, and the alignment is performed using the feature pattern of the second divisional data.
